(19) United States
(12) Patent Application Publication
(10) Pub. No.: US 2019/0181672 A1
(43) Pub. Date: Jun. 13, 2019

(54) CHARGING SYSTEM AND CHARGING METHOD FOR INTELLIGENT ROBOT

(71) Applicant: AROBOT INNOVATION CO., LTD., New Taipei City (TW)

(72) Inventors: WEN-PING LIU, New Taipei City (TW); YUNG-HSING YIN, New Taipei City (TW); CHI-HAO KAO, New Taipei City (TW); JEN-CHIEH PAN, New Taipei City (TW)

(21) Appl. No.: 15/926,201

(22) Filed: Mar. 20, 2018

(30) Foreign Application Priority Data
Dec. 8, 2017 (TW) 106143190

(51) Int. Cl. H02J 7/02; H02J 50/12

(52) U.S. Cl. CPC H02J 7/025; H02J 50/12

(57) ABSTRACT

Disclosed is a charging system and charging method for an intelligent robot, including a central processing unit, a charging base, a base connector, a wireless charging module and a power socket. The charging base used to charge the intelligent robot via the base connector. The wireless charging module used to charge the intelligent robot when the intelligent robot proceeds to the wireless charging module. When the intelligent robot is charged by at least two charging path of two of the charging base, the wireless charging module or the power socket, the central processing unit controls the earliest connected charging path to receive energy and turns off the other charging paths.

### BACKGROUND OF THE INVENTION

### 1. Field of the Invention

The instant disclosure relates to a charging system, and in particular, to a charging system and a charging method for an intelligent robot.

### 2. Description of Related Art

With the development of technology, robots have replaced the need for manual labor in work requiring hard labor, for example, using mechanical arms for heavy lifting or complicated processes. In recent years, domestic robots have been widely accepted by people, and may be used for domestic cleaning and human-robot interaction. However, the charging path of robots generally lacks auto protection mechanisms, which may damage the circuitry.

### SUMMARY OF THE INVENTION

The instant disclosure provides a charging system for an intelligent robot. The charging system includes a battery providing electrical energy to the intelligent robot. The charging system includes a central processing unit, a charging base, a base interface, a wireless charging module and a power socket. The central processing unit is configured to control the intelligent robot to receive electrical energy or stop receiving electrical energy. The charging base is configured to charge the intelligent robot and has an arc surface. The base interface is electrically connected to the central processing unit and is configured to connect to the charging base. When the intelligent robot proceeds to the center of the arc surface, the base interface is connected with the charging base, the charging base charges the intelligent robot through the base interface. When the intelligent robot proceeds to the wireless charging module and is electromagnetically coupled to the wireless charging module, the wireless charging module charges the intelligent robot. The power socket is electrically connected to the central processing unit. When the power socket is connected to a domestic power source, the domestic power source charges the intelligent robot through the power socket. The central processing unit is configured to determine whether the intelligent robot receives power from one or more power sources. When the intelligent robot is charged by one charging path of the charging base, the wireless charging module or the power socket, the central processing unit turns on one charging path and turns off the other charging paths. When the intelligent robot is charged by at least two charging paths of two of the charging base, the wireless charging module or the power socket, the central processing unit controls the earliest connected charging path to receive energy and turns off the other charging path, and a wireless communication module transmits a warning signal to a mobile device.

The instant disclosure further provides a charging method for an intelligent robot. A charging system includes a battery that is configured to charge the intelligent robot. The charging system includes a central processing unit, a charging base, a base interface, a wireless charging module and a charging socket. The central processing unit is electrically connected to the charging base, the base interface, the wireless charging module and the charging socket. The charging method includes: controlling the intelligent robot to receive electrical energy or stop receiving electrical energy by the central processing unit; charging the intelligent robot by the charging base which includes an arc surface; charging the intelligent robot through the base interface by the charging base when the intelligent robot proceeds to the center of the arc surface, and the base interface is connected with the charging base; charging the intelligent robot by the wireless charging module when the intelligent robot proceeds to the wireless charging module, and the wireless charging module is electromagnetically coupled to the intelligent robot; and charging the intelligent robot through the power socket by a domestic power source when the power socket is connected to the domestic power source. The central processing unit is configured to determine whether the intelligent robot receives power from one or more power sources. When the intelligent robot is charged by one charging path of one of the charging base, the wireless charging module or the power socket, the central processing unit turns on one charging path and turns off the other charging paths. When the intelligent robot is charged by at least two charging paths of two of the charging base, the wireless charging module or the power socket, the central processing unit controls the earliest connected charging path to receive energy and turns off the other charging paths, and a wireless communication module transmits a warning signal to a mobile device.

For further understanding of the instant disclosure, reference is made to the following detailed description illustrating the embodiments of the instant disclosure. The description is only for illustrating the instant disclosure, and should not be construed as limiting the scope of the claim.

### BRIEF DESCRIPTION OF THE DRAWINGS

Embodiments are illustrated by way of example and not by way of limitation in the figures of the accompanying drawings, in which like references indicate similar elements and in which:

FIG. 1 shows a block diagram of a charging system for an intelligent robot according to one embodiment of the instant disclosure.

FIG. 2 shows a block diagram of the charging system for an intelligent robot according to another embodiment of the instant disclosure.

FIG. 3 shows a flow chart of a charging method for an intelligent robot according to one embodiment of the instant disclosure.

FIG. 4 shows a flow chart of the charging method for an intelligent robot according to another embodiment of the instant disclosure.

FIG. 5 shows a perspective view illustrating an intelligent robot being connected to a charging base according to one embodiment of the instant disclosure.

### DETAILED DESCRIPTION OF PREFERRED EMBODIMENTS

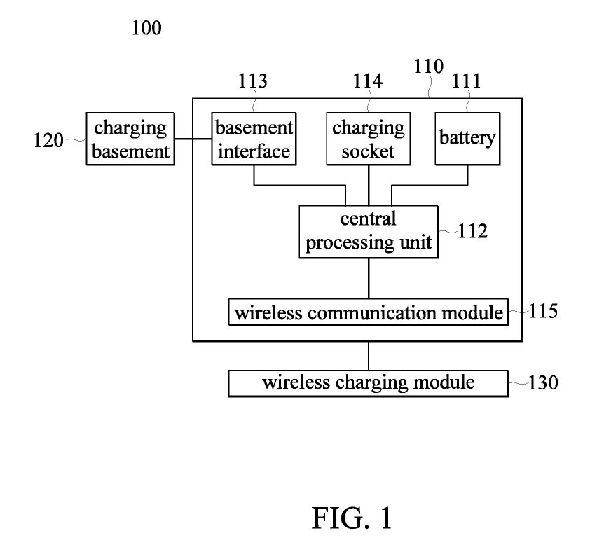

Reference is made to FIG. 1. FIG. 1 shows a block diagram of a charging system for an intelligent robot according to one embodiment of the instant disclosure.

The charging system 100 includes an intelligent robot 110, a charging base 120 and a wireless charging module 130. More specifically, the intelligent robot 110 includes a battery 111, a central processing unit 112, a base interface 113, a charging socket 114 and a wireless communication module 115. The central processing unit 112 is electrically connected to the battery 111, the base interface 113, the charging socket 114 and the wireless communication module 115. The battery 111 is configured to provide electrical energy to electronic components of the intelligent robot 110, and may be a lithium battery cell. The central processing unit 112 is configured to control the intelligent robot 120 to receive electrical energy or stop receiving electrical energy. The intelligent robot 110 may include a plurality of charging paths. The central processing unit 112 may automatically change the charging path according to the charging efficiency of the battery 111. For example, the central processing unit 112 may automatically switch to another charging path when the charging efficiency of the battery 111 being below 30%.

The charging base 120 is configured to charge the battery 111 of the intelligent robot 110. The charging base 120 includes an arc surface. The base interface 113 is electrically connected to the central processing unit 112. The base interface 113 is configured to connect with the charging base 120. When the intelligent robot 110 proceeds to the center of the arc surface, the base interface 113 is connected with the charging base 120. The charging base 120 charges the intelligent robot 110 through the base interface 113. More specifically, the arc surface of the charging base 120 has a beneficial effect on the base interface 113 in order to charge the intelligent robot 110. The intelligent robot 110 may include a camera (not shown) that is configured to detect the curvature on the ground. The intelligent robot 110 proceeds to the charging base 113 when the camera detects that the ground has changed from a flat surface to an arced surface.

When the intelligent robot 110 proceeds to the wireless charging module 130, the wireless charging module 130 is electromagnetically coupled to the intelligent robot 110. For example, the wireless charging module 130 is able to receive or transmit electromagnetic energy to the intelligent robot 110 by magnetic induction or magnetic resonance, and the wireless charging module 130 charges the intelligent robot 110. For example, the intelligent robot 110 automatically proceeds to the wireless charging module 130 when the electric quantity of the battery 111 is below 15%. The intelligent robot 110 receives an electromagnetic energy from the wireless charging module 130, and a converting circuitry (not shown) transforms the electromagnetic energy into electrical energy and stores the same in the battery 111. When the power socket 114 is connected to a domestic power source, the domestic power source charges the intelligent robot 110 through the power socket 114. For example, the charging socket 114 may be connected to the intelligent robot 110 via an extensible wire. The charging socket 114 may be retracted to be disposed in the intelligent robot 110 when the electric quantity of the battery 111 is ample.

The central processing unit 112 is configured to determine whether the intelligent robot 110 receives power from one or more power sources. In other words, the intelligent robot 110 may receive power from one power source or multiple power sources simultaneously. When the intelligent robot 110 is charged by one charging path of one of the charging base 120, the wireless charging module 130 or the power socket 114, the central processing unit 112 turns on one charging path and turns off the other charging paths. When the intelligent robot 110 is charged by at least two charging paths of two of the charging base 120, the wireless charging module 130 or the power socket 114, the central processing unit 112 controls the earliest connected charging path to receive energy and turns off the other charging paths, and a wireless communication module 115 transmits a warning signal to a mobile device (not shown). The mobile device may be a smartphone, a tablet or a laptop. A user may download software in order to examine the electric quantity of the battery 111. The wireless communication module 115 transmits the warning signal to the user's smartphone when the electric quantity is below a predetermined value for informing the user that the intelligent robot 110 is needed to be charged.

For example, the charging base 120 may also be referred to herein as “a first charging path”, the wireless charging module 130 may also be referred to herein as “a second charging path”, and the charging socket 114 may also be referred to herein as “a third charging path”. When the first charging path is turned on, the central processing unit 112 turns off the second charging path and the third charging path. When the second charging path and the third charging paths are turned on respectively and sequentially, the central processing unit 112 turns on the first charging path and turns off the second charging path.

When the intelligent robot 110 stops receiving power from one charging path of one of the charging base 120, the wireless charging module 130 or the power socket 114, the central processing unit 112 turns off the charging path. For example, when the charging socket 114 stops receiving energy, the central processing unit 112 turns off the second charging path.

When the intelligent robot 110 is changed from being charged by at least two charging paths of two of the charging base 120, the wireless charging module 130 or the power socket 114 to being charged by one charging path of one of the charging base 120, the wireless charging module 130 or the power socket 114, the central processing unit 112 turns on a charging path. For example, when the intelligent robot 110 is changed from being charged simultaneously by the charging base 120 and the wireless charging module 130 to being charged only by the charging base 120, the central processing unit 112 turns on the first charging path.

When the intelligent robot 110 is changed from being charged by the charging base 120, the wireless charging module 130 and the power socket 114 to being charged by two charging paths of two of the charging base 120, the wireless charging module 130 or the power socket 114, the central processing unit 112 controls the earliest connected charging path to receive energy and turns off the other charging paths, and the wireless communication module 115 transmits the warning signal to the mobile device. For example, when the intelligent robot 110 is changed from being simultaneously charged by the charging base 120, the wireless charging module 130 and the charging socket 114 to being sequentially charged by the charging base 120 and the wireless charging module 130, the central processing unit 112 turns on the first charging path and turns off the second charging path and the third charging path.

When the intelligent robot 110 is charged by at least two charging paths of two of the charging base 120, the wireless charging module 130 or the power socket 114, the central processing unit 112 turns off all charging paths, and the wireless communication module 115 transmits the warning signal to the mobile device. For example, when the intelligent robot 110 is charged by the charging base 120 and the wireless charging module 130 simultaneously, the central processing unit 112 turns off the first charging path, the second charging path and the third charging path for power safety.

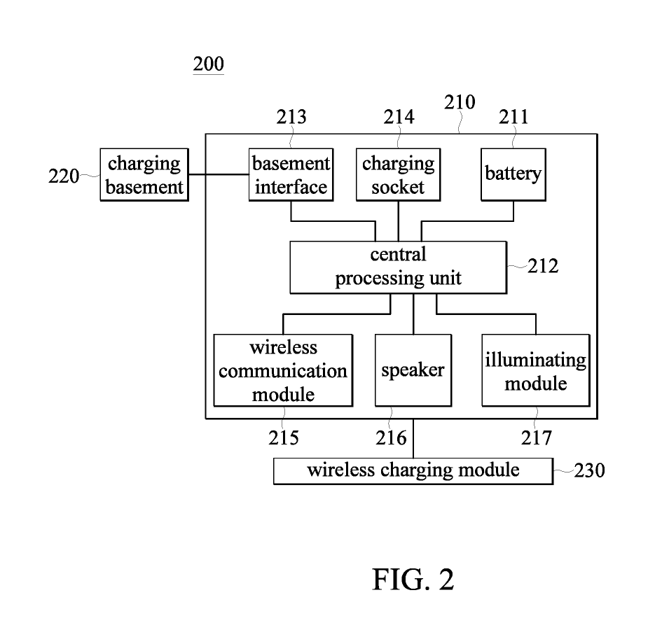

Reference is made to FIG. 2. FIG. 2 shows a block diagram of the charging system for an intelligent robot according to another embodiment of the instant disclosure.

The charging system 200 includes an intelligent robot 210, a charging base 220 and a wireless charging module 230. More specifically, the intelligent robot 210 includes a battery 211, a central processing unit 212, a base interface 213, a charging socket 214, a wireless communication module 215, a speaker 216 and an illuminating module 217. The central processing unit 212 is electrically connected to the battery 211, the base interface 213, the charging socket 214, the wireless communication module 215, the speaker 216 and the illuminating module 217. When the intelligent robot 210 is charged by at least two charging paths of two of the charging base 220, the wireless charging module 230 or the power socket 214, the speaker 216 emits a sound. For example, when the intelligent robot 210 is charged by the wireless charging module 230 and the charging socket 214 simultaneously, the speaker 216 emits a short sound. When the intelligent robot 210 is charged by at least two charging paths of two of the charging base 220, the wireless charging module 230 or the power socket 214, the illuminating module 217 emits a warning light. For example, when the intelligent robot 210 is charged by the charging base 220 and the charging socket 214 simultaneously, the illuminating module 217 emits a flashing red light.

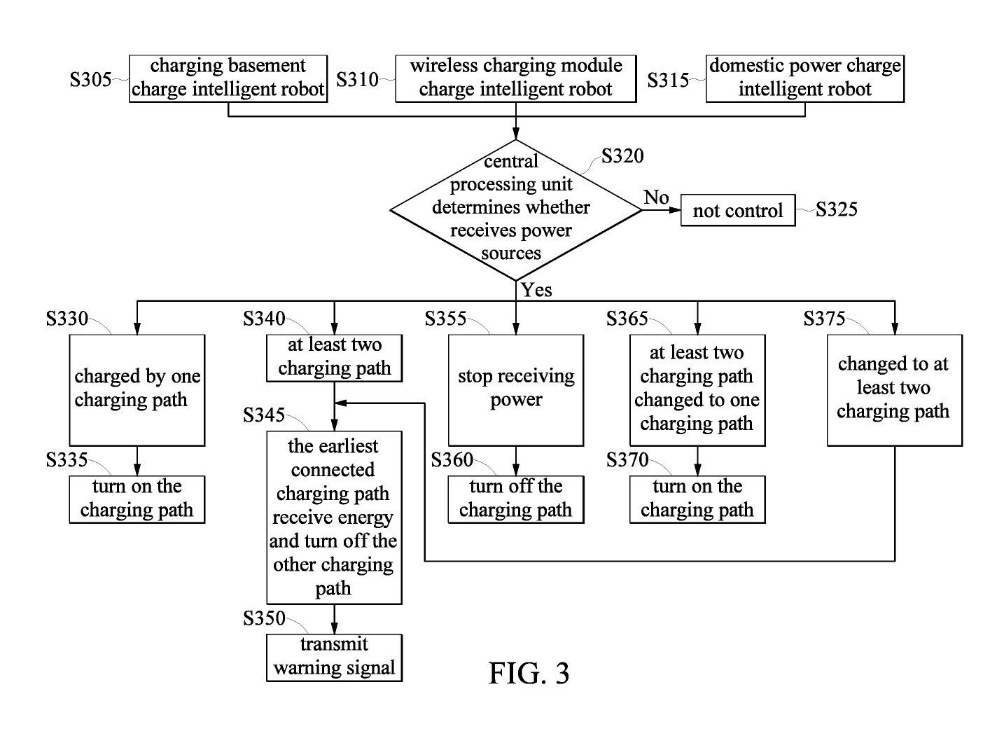

Reference is made to FIG. 1 and FIG. 3. FIG. 3 shows a flow chart of a charging method for an intelligent robot according to one embodiment of the instant disclosure. The charging method is applied to a charging system 100.

The charging system 100 includes a battery 111 that is configured to charge the intelligent robot 110. The charging system 100 includes a central processing unit 112, a charging base 120, a base interface 113, a wireless charging module 130 and a charging socket 114. The central processing unit 112 is electrically connected to the charging base 120, the base interface 113, the wireless charging module 130 and the charging socket 114. The central processing unit 112 controls the intelligent robot 110 to receive electrical energy or stop receiving electrical energy.

In Step S305 of the charging method, the charging base 120 charges the intelligent robot 110. The charging base 120 includes an arc surface. The base interface 113 is connected with the charging base 120. When the intelligent robot 110 proceeds to the center of the arc surface, the base interface 113 is connected with the charging base 120, and the charging base 120 charges the intelligent robot 110 through the base interface 113.

In Step S310, when the intelligent robot 110 proceeds to the wireless charging module 130, the wireless charging module 130 is electromagnetically coupled to the intelligent robot 110, and the wireless charging module 130 charges the intelligent robot 110.

In Step S315, when the power socket 114 is connected to a domestic power source, the domestic power source charges the intelligent robot 110 through the power socket 114.

In Step S320, the central processing unit 112 determines whether the intelligent robot 110 receives power from one or more power sources. If not, the method proceeds to Step S325; but if yes, the method proceeds to Step S330, Step S340, Step S355, Step S365 or Step S375.

In Step S325, the central processing unit 112 does not control the charging path.

In Step S330, the intelligent robot 110 is charged by one charging path of one of the charging base 120, the wireless charging module 130 or the charging socket 114.

In Step S335, the central processing unit 112 turns on the charging path.

In Step S340, the intelligent robot 110 is charged by at least two charging paths of two of the charging base 120, the wireless charging module 130 or the charging socket 114.

In Step S345, the central processing unit 112 controls the earliest connected charging path to receive energy and turns off the other charging paths.

In Step S350, a wireless communication module 115 transmits a warning signal to a mobile device.

In Step S355, the intelligent robot 110 stops receiving power from one charging path of the charging base 120, the wireless charging module 130 or the power socket 114.

In Step S360, the central processing unit 112 turns off the charging path.

In Step S365, the intelligent robot 110 is changed from being charged by at least two charging paths of two of the charging base 120, the wireless charging module 130 or the power socket 114 to being charged by one charging path of one of the charging base 120, the wireless charging module 130 or the power socket 114.

In Step S370, the central processing unit 112 turns on the charging path.

In Step S375, the intelligent robot 110 is changed from being charged by the charging base 120, the wireless charging module 130 and the power socket 114 to being charged by at least two charging path of two of the charging base 120, the wireless charging module 130 or the power socket 114, and the method proceeds to Step S345 and Step S350.

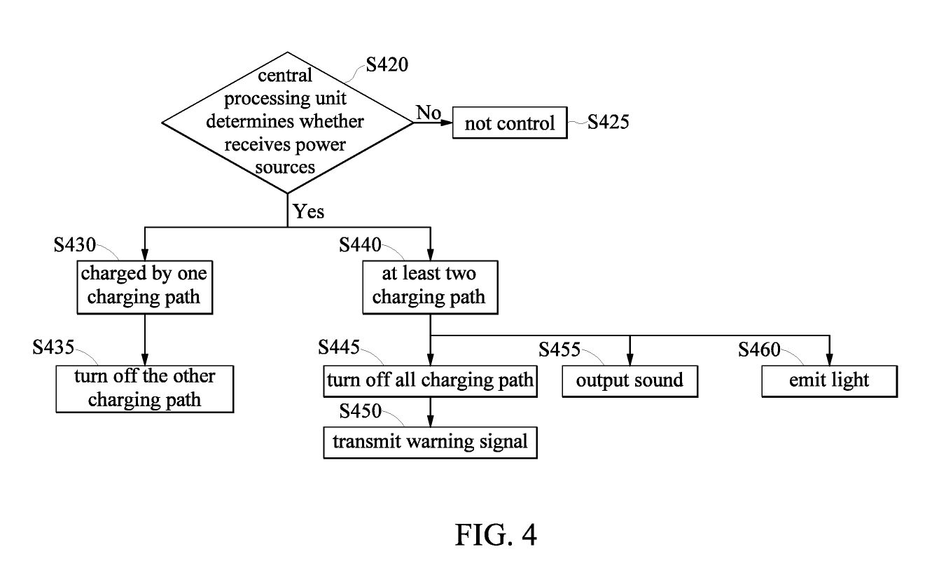

Reference is made to FIG. 2 and FIG. 4. FIG. 4 shows a flow chart of the charging method for an intelligent robot according to another embodiment of the instant disclosure.

In Step S420 of the charging method, the central processing unit 212 determines whether the intelligent robot 210 receives power from one or more power sources. If not, the method proceeds to Step S425; but if yes, the method proceeds to Step S430 or Step S440.

In Step S425, the central processing unit 220 does not control the charging path.

In Step S430, the intelligent robot 210 is charged by one charging path of one of the charging base 220, the wireless charging module 230 or the charging socket 214.

In Step S435, the central processing unit 212 turns on one charging path and turns off the other charging paths.

In Step S440, the intelligent robot 210 is charged by at least two charging paths of two of the charging base 220, the wireless charging module 230 or the charging socket 214.

In Step S445, the central processing unit 212 turns off all charging paths.

In Step S450, the wireless communication module 215 transmits a warning signal to a device.

In Step S455, a speaker 216 emits a sound.

In Step S460, an illuminating module 217 emits a light.

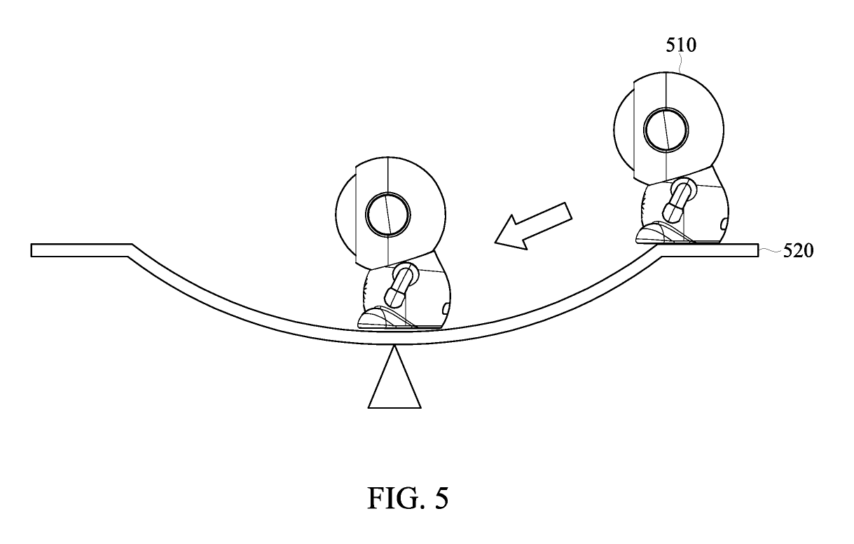

Reference is made to FIG. 5. FIG. 5 shows a perspective view illustrating an intelligent robot being connected to a charging base according to one embodiment of the instant disclosure. When the intelligent robot 510 proceeds to the center of the charging base 520 which includes an arc surface, the charging base 520 charges the intelligent robot 510.

To sum up, the instant disclosure provides a charging system for an intelligent robot. The intelligent robot may be charged by a charging base, a wireless charging module or a charging socket. The charging base, the wireless charging module and the charging socket are taken as a first charging path, a second charging path and a third charging path, respectively. When the intelligent robot is charged by at least two charging paths of two of the charging base, the wireless charging module or the power socket, the central processing unit controls the earliest connected charging path to receive energy and turns off the other charging paths, and a wireless communication module transmits a warning signal to a mobile device. A speaker emits a warning sound and an illuminating module emits a light, so that the functionality of the intelligent robot is enhanced.

The descriptions illustrated supra set forth simply the preferred embodiments of the instant disclosure; however, the characteristics of the instant disclosure are by no means restricted thereto. All changes, alterations, or modifications conveniently considered by those skilled in the art are deemed to be encompassed within the scope of the instant disclosure delineated by the following claims.

What is claimed is:

1. A charging system for an intelligent robot, the charging system including a battery providing electrical energy to the intelligent robot, the charging system comprising:
a central processing unit configured to control the intelligent robot to receive electrical energy or stop receiving electrical energy;
a charging base configured to charge the intelligent robot, the charging base including an arc surface;
a base interface being electrically connected to the central processing unit, the base interface being configured to connect with the charging base, when the intelligent robot proceeds to the center of the arc surface, the base interface is connected with the charging base, and the charging base charges the intelligent robot through the base interface;
a wireless charging module, when the intelligent robot proceeds to the wireless charging module, the wireless charging module electromagnetically coupled to the intelligent robot, and the wireless charging module charges the intelligent robot; and
a power socket electrically connected to the central processing unit, when the power socket connects to a domestic power source, the domestic power source charges the intelligent robot through the power socket;
wherein the central processing unit is configured to determine whether the intelligent robot receives power from one or more power sources, when the intelligent robot is charged by one charging path of one of the charging base, the wireless charging module or the power socket, the central processing unit turns on one charging path and turns off the other charging paths, when the intelligent robot is charged by at least two charging paths of two of the charging base, the wireless charging module or the power socket, the central processing unit controls the earliest connected charging path to receive energy and turns off the other charging paths, and a wireless communication module transmits a warning signal to a mobile device.

2. The charging system according to claim 1, wherein when the intelligent robot stops receives power from one charging path of one of the charging base, the wireless charging module or the power socket, the central processing unit turns off the charging path.

3. The charging system according to claim 1, wherein when the intelligent robot is changed from being charged by at least two charging paths of two of the charging base, the wireless charging module or the power socket to being charged by one charging path of one of the charging base, the wireless charging module or the power socket, the central processing unit turns on the charging path.

4. The charging system according to claim 1, wherein when the intelligent robot is changed from being charged by the charging base, the wireless charging module and the power socket to being charged by at least two charging path of two of the charging base, the wireless charging module or the power socket, the central processing unit controls the earliest connected charging path to receive energy and turns off the other charging paths, and the wireless communication module transmits the warning signal to the mobile device.

5. The charging system according to claim 1, wherein when the intelligent robot is charged by at least two charging paths of two of the charging base, the wireless charging module or the power socket, the central processing unit turns off all charging paths, and the wireless communication module transmits the warning signal to the mobile device.

6. The charging system according to claim 1, including:
a speaker electrically connected to the central processing unit, when the intelligent robot is charged by at least two charging paths of two of the charging base, the wireless charging module or the power socket, the speaker outputs a sound.

7. The charging system according to claim 1, including:
an illuminating module electrically connected to the central processing unit, when the intelligent robot is charged by at least two charging paths of two of the charging base, the wireless charging module or the power socket, the illuminating module emits a warning light.

8. A charging method for an intelligent robot, the charging method being applied to a charging system, the charging system including a battery configured to charge the intelligent robot, the charging system including a central processing unit, a charging base, a base interface, a wireless charging module and a charging socket, the central processing unit being electrically connected to the charging base, the base interface, the wireless charging module and the charging socket, the charging method comprising:
controlling the intelligent robot to receive electrical energy or stop receiving electrical energy by the central processing unit;
charging the intelligent robot by the charging base, the charging base including an arc surface;
charging the intelligent robot through the base interface by the charging base when the intelligent robot proceeds to the center of the arc surface, the base interface being connected with the charging base;
charging the intelligent robot by the wireless charging module when the intelligent robot proceeds to the wireless charging module, the wireless charging module being electromagnetically coupled to the intelligent robot; and
charging the intelligent robot through the power socket by a domestic power source when the power socket is connected to the domestic power source;
wherein the central processing unit is configured to determine whether the intelligent robot receives power from one or more power sources, when the intelligent robot is charged by one charging path of one of the charging base, the wireless charging module or the power socket, the central processing unit turns on one charging path and turns off the other charging paths, when the intelligent robot is charged by at least two charging path of two of the charging base, the wireless charging module or the power socket, the central processing unit controls the earliest connected charging path to receive energy and turns off the other charging paths, and a wireless communication module transmits a warning signal to a mobile device.

9. The charging method according to claim 8, wherein when the intelligent robot stops receiving power from one charging path of one of the charging base, the wireless charging module or the power socket, the central processing unit turns off the charging path.

10. The charging method according to claim 8, wherein when the intelligent robot is changed from being charged by at least two charging paths of two of the charging base, the wireless charging module or the power socket to being charged by one charging path of one of the charging base, the wireless charging module or the power socket, the central processing unit turns on the charging path.

11. The charging method according to claim 8, wherein when the intelligent robot is changed from being charged by the charging base, the wireless charging module and the power socket to being charged by at least two charging path of two of the charging base, the wireless charging module or the power socket, the central processing unit controls the earliest connected charging path to receive energy and turns off the other charging paths, and the wireless communication module transmits the warning signal to the mobile device.

12. The charging method according to claim 8, wherein when the intelligent robot is charged by at least two charging path of two of the charging base, the wireless charging module or the power socket, the central processing unit turns off all charging paths, and the wireless communication module transmits the warning signal to the mobile device.

13. The charging method according to claim 8, the charging system including a speaker electrically connected to the central processing unit, the charging method comprising:
when the intelligent robot is charged by at least two charging paths of two of the charging base, the wireless charging module or the power socket, the speaker emits a sound.

14. The charging method according to claim 8, the charging system including an illuminating module electrically connected to the central processing unit, the charging method comprising:
when the intelligent robot is charged by at least two charging paths of two of the charging base, the wireless charging module or the power socket, the illuminating module emits a warning light.
